(19) United States
(12) Patent Application Publication
(10) Pub. No.: US 2018/0182585 A1
(43) Pub. Date: Jun. 28, 2018

(54) ELECTROMAGNETIC RELAY

(71) Applicant: FUJITSU COMPONENT LIMITED, Tokyo (JP)

(72) Inventor: Nobuyoshi Hiraiwa, Tokyo (JP)

(21) Appl. No.: 15/835,700

(22) Filed: Dec. 8, 2017

(30) Foreign Application Priority Data
Dec. 28, 2016 (JP) 2016-255823

(51) Int. Cl. H01H 50/44; H01H 50/56; H01H 50/14

(52) U.S. Cl. CPC H01H 50/44; H01H 2050/446; H01H 50/14; H01H 50/56

(57) ABSTRACT

An electromagnetic relay includes a base, a bobbin fixed to the base, a coil attached to the bobbin, a movable spring terminal fixed to the base, a movable spring fixed to the movable spring terminal and including a movable contact, and a fixed terminal fixed to the base. The fixed terminal includes a contact part on which a fixed contact is provided and a terminal part absent in a plane in which the contact part is positioned. The terminal part includes a press-fitting protrusion press-fitted into an opening of the bobbin.

### CROSS-REFERENCE TO RELATED APPLICATION

The present application is based upon and claims priority to Japanese Patent Application No. 2016-255823, filed on Dec. 28, 2016, the entire contents of which are incorporated herein by reference.

### BACKGROUND OF THE INVENTION

### 1. Field of the Invention

The present invention relates to electromagnetic relays.

### 2. Description of the Related Art

Products using direct-current (DC) high voltage, such as electric cars, photovoltaics, and large DC apparatuses, have recently been widely used, and such products employ an electromagnetic relay supporting DC high voltage. When the electromagnetic relay performs on-off control of DC high voltage, arc discharge occurs particular when contacts are opened (separated). When the contacts become worn or melt to be bonded together because of such arc discharge, the electromagnetic relay may malfunction. Thus, some electromagnetic relays include a magnet or an arc runner for arc suppression to improve arc suppression performance to support DC high voltage. There is a demand for the downsizing of such electromagnetic relays with a magnet or an arc runner. Reference may be made to Japanese Laid-open Patent Publication Nos. 2014-49315 and 2014-116165 for related art.

### SUMMARY OF THE INVENTION

According to an aspect of the present invention, an electromagnetic relay includes a base, a bobbin fixed to the base, a coil attached to the bobbin, a movable spring terminal fixed to the base, a movable spring fixed to the movable spring terminal and including a movable contact, and a fixed terminal fixed to the base. The fixed terminal includes a contact part on which a fixed contact is provided and a terminal part absent in a plane in which the contact part is positioned. The terminal part includes a press-fitting protrusion press-fitted into an opening of the bobbin.

### BRIEF DESCRIPTION OF THE DRAWINGS

FIG. 1 is a perspective view of an electromagnetic relay according to an embodiment;

FIG. 2 is a diagram illustrating a flow of electric current through the electromagnetic relay according to the embodiment;

FIGS. 3A and 3B are diagrams illustrating a movable spring and a movable spring terminal of the electromagnetic relay according to the embodiment;

FIGS. 4A through 4F are diagrams illustrating the assembling of an electromagnetic relay according to the embodiment;

FIGS. 5A through 5D are diagrams illustrating a bonding process in the manufacture of an electromagnetic relay according to the embodiment;

FIGS. 6A through 6C are diagrams illustrating the connection of fixed terminals of a comparative electromagnetic relay;

FIGS. 7A and 7B are diagrams illustrating the connection of fixed terminals of the electromagnetic relay according to the embodiment;

FIGS. 8A and 8B are diagrams illustrating the connection of the fixed terminals of the electromagnetic relay according to the embodiment; and

FIGS. 9A and 9B are diagrams illustrating the connection of the fixed terminals of the electromagnetic relay according to the embodiment.

### DESCRIPTION OF THE EMBODIMENTS

In the electromagnetic relay, a fixed terminal on which a fixed contact is formed is connected to, for example, a bobbin formed of an insulating mold resin. The fixed terminal may be disengaged from the bobbin because of heat when a large direct current flows or an arc is frequently generated. In this case, the electromagnetic relay becomes unusable. Furthermore, when attaching the fixed terminal to the bobbin by, for example, press fitting, the bobbin formed of a mold resin may be scrapped off by part of the fixed terminal press-fitted to the bobbin, thus causing adhesion of the shavings of the mold resin to, for example, the fixed terminal. In such a case, the electrical connection between contacts may fail. Therefore, there is a demand for highly reliable electromagnetic relays.

According to an aspect of the present invention, the reliability of an electromagnetic relay is increased.

One or more embodiments of the present invention are described below with reference to the accompanying drawings. In the following, the same elements or members are referred to using the same reference numeral, and their description is not repeated.

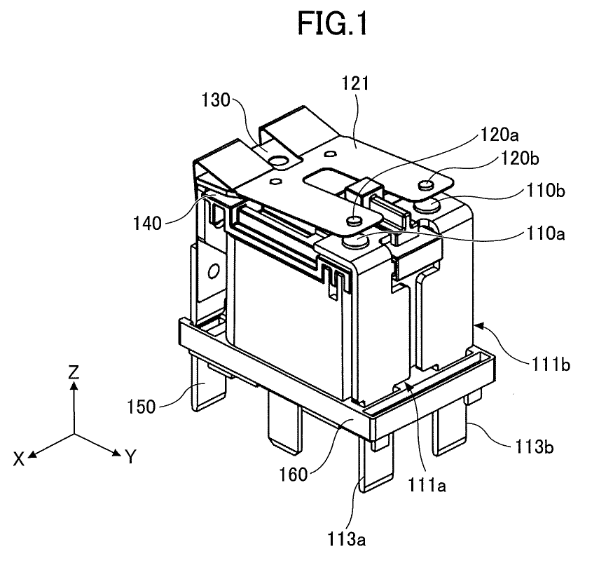

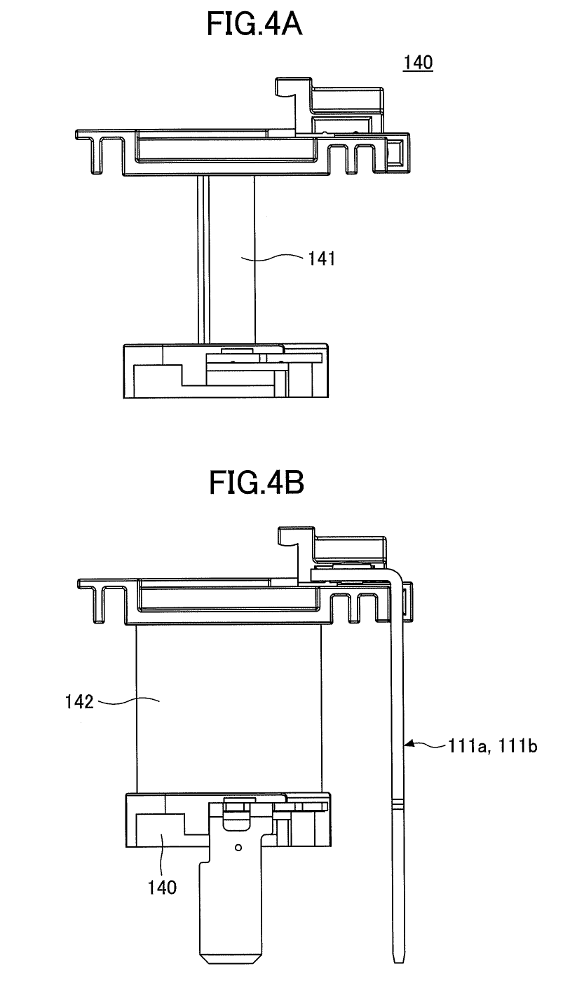

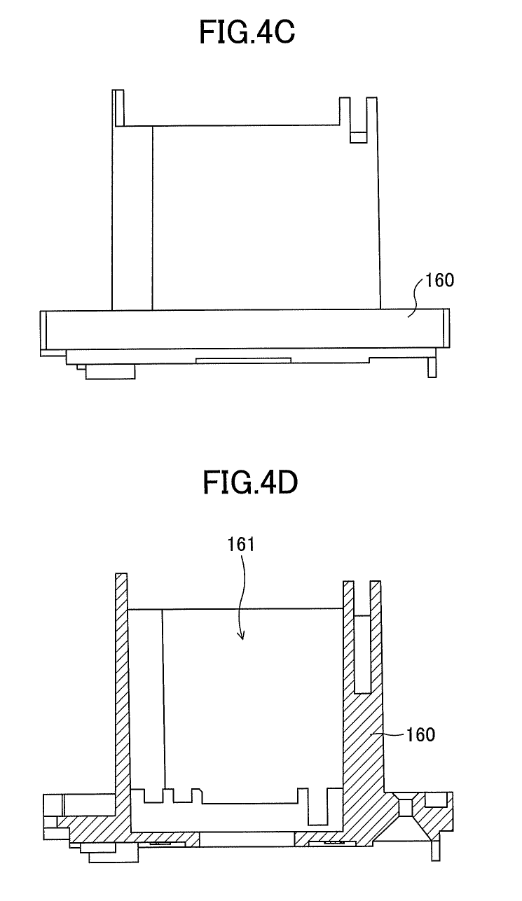

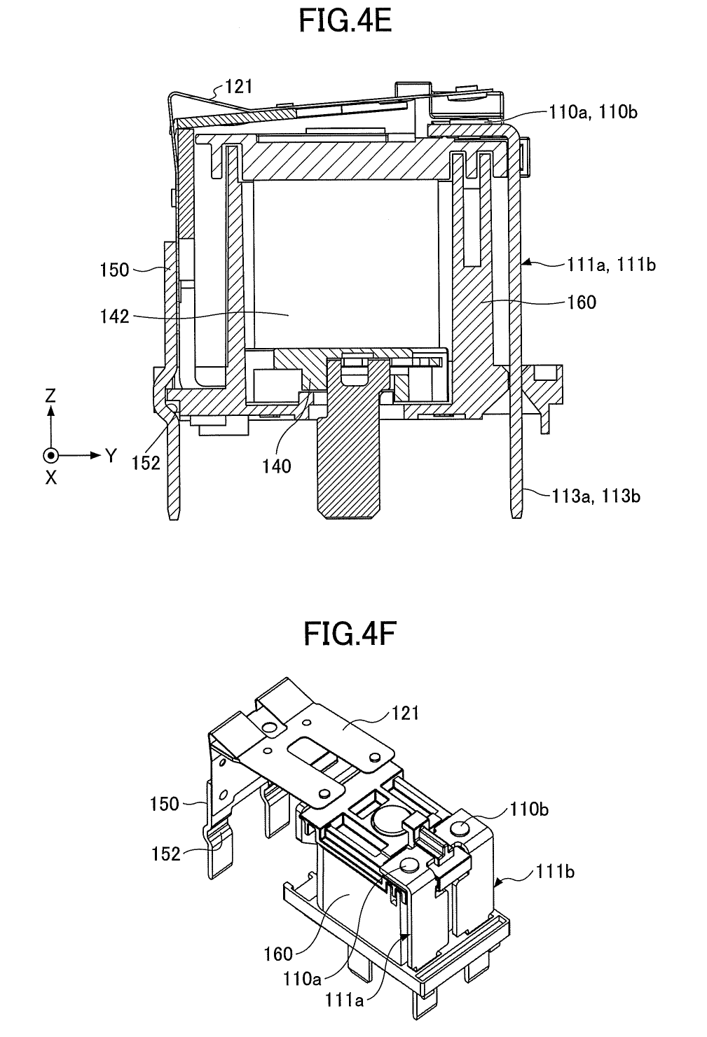

FIG. 1 is a perspective view of an electromagnetic relay according to an embodiment. Referring to FIG. 1, the electromagnetic relay includes a fixed terminal 111a on which a fixed contact 110a is provided, a fixed terminal 111b on which a fixed contact 110b is provided, a movable spring 121 on which movable contacts 120a and 120b are provided, an armature 130, a bobbin 140 on which a coil 142 (FIG. 4B) is wound, a movable spring terminal 150, and a base 160. The bobbin 140 is formed of a resin material. The fixed terminals 111a and 111b are attached to the bobbin 140.

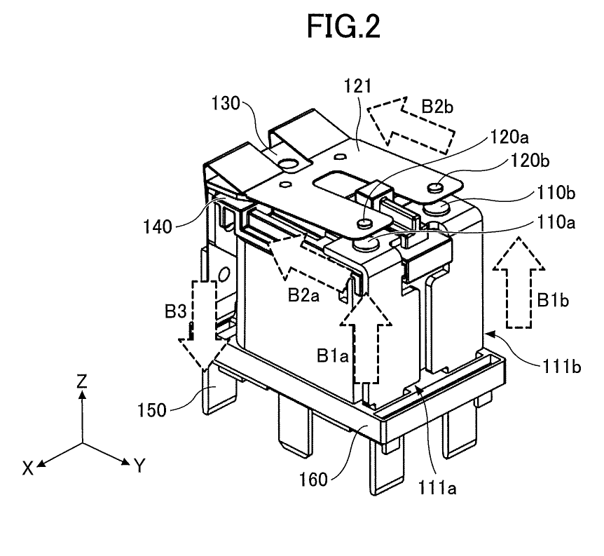

The electromagnetic relay of this embodiment includes two each of a fixed contact and a movable contact, namely, the fixed contacts 110a and 110b and the movable contacts 120a and 120b. The fixed contact 110a and the movable contact 120a form a pair, and the fixed contact 110b and the movable contact 120b form a pair. FIG. 2 is a diagram illustrating a flow of electric current through the electromagnetic relay according to this embodiment. Referring to FIG. 2, when the fixed contact 110a contacts the movable contact 120a and the fixed contact 110b contacts the movable contact 120b, an electric current flowing from the fixed terminal 111a to the fixed contact 110a to the movable contact 120a to the movable spring 121 as indicated by the dashed arrows B1a and B2a and an electric current flowing from the fixed terminal 111b to the fixed contact 110b to the movable contact 120b to the movable spring 121 as indicated by the dashed arrows B1b and B2b merge at the movable spring 121 to flow to the movable spring terminal 150 as indicated by the dashed arrow B3.

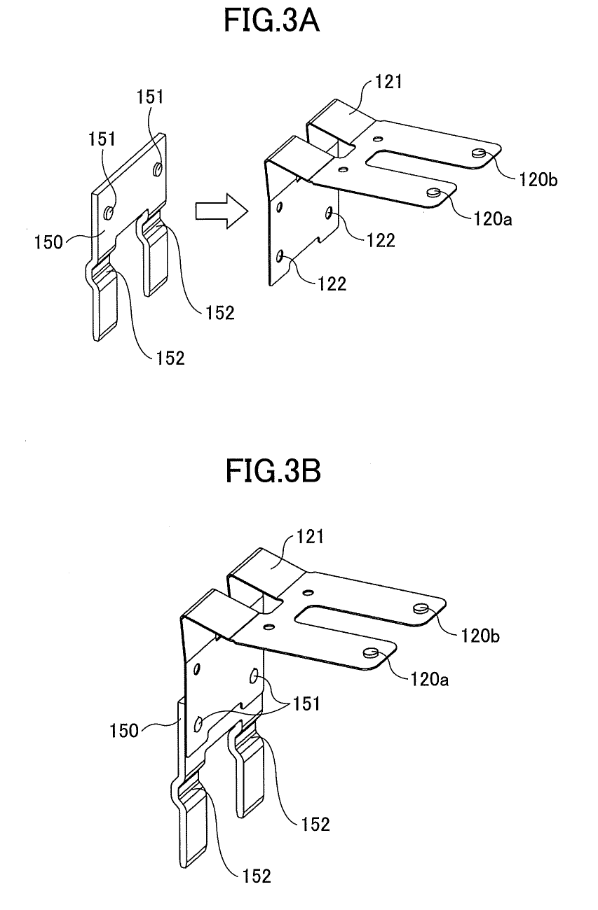

FIGS. 3A and 3B are diagrams illustrating the movable spring 121 and the movable spring terminal 150. FIG. 3A illustrates the movable spring 121 and the movable spring terminal 150 before being connected, and FIG. 3B illustrates the movable spring 121 and the movable spring terminal 150 that are connected. According to the electromagnetic relay of this embodiment, the movable spring terminal 150 is joined to the movable spring 121 by inserting projections 151 of the movable spring terminal 150 into corresponding holes 122 formed in the movable spring 121 and applying pressure on the ends of the projections 151 so that the ends of the projections 151 deform to extend onto a surface of the movable spring 121.

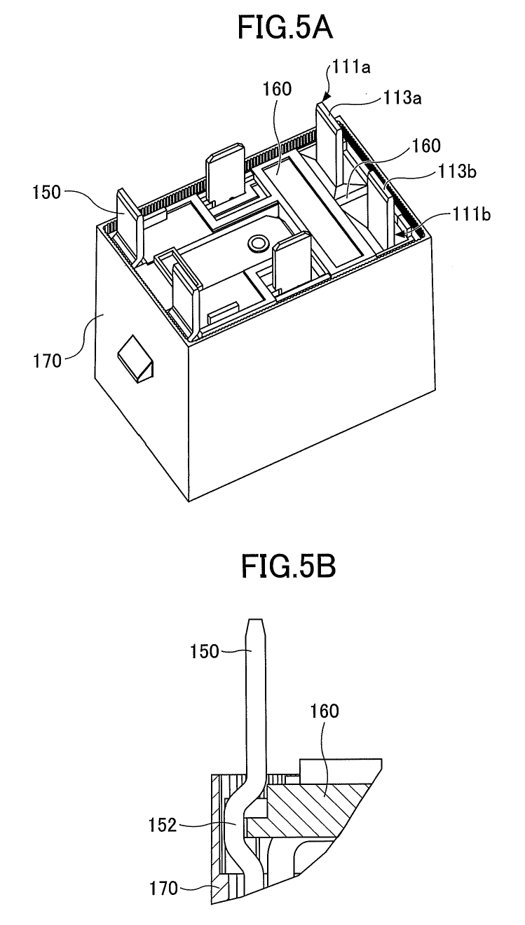

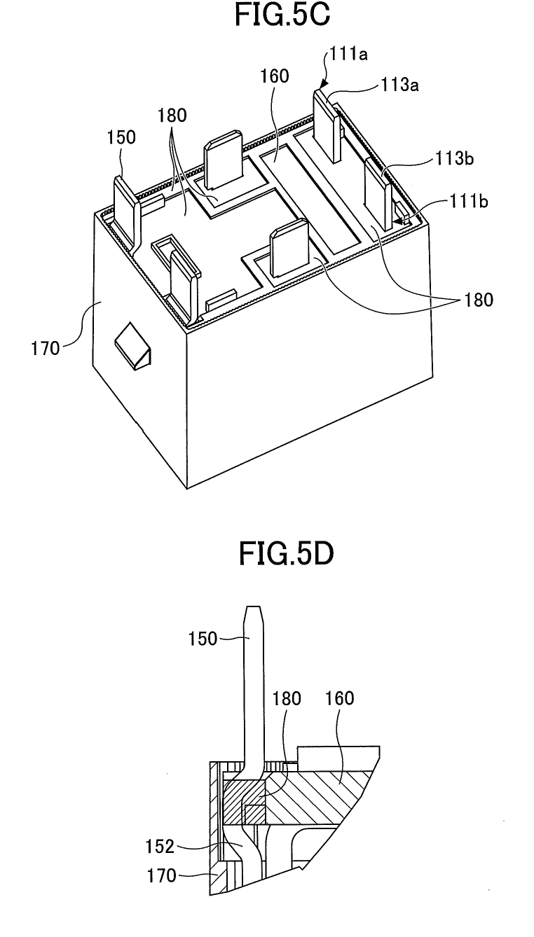

Next, the manufacture of an electromagnetic relay according to this embodiment is described. FIGS. 4A through 4F are diagrams illustrating the assembling of an electromagnetic relay according to this embodiment. FIGS. 5A through 5D are diagrams illustrating a bonding process in the manufacture of an electromagnetic relay according to this embodiment. According to this embodiment, the bobbin 140 depicted in FIG. 4A is used. Referring to FIGS. 4A and 4B, a coil wire is wound on a shaft 141 of the bobbin 140 to form the coil 142, and the fixed terminals 111a and 111b are attached to the bobbin 140. The bobbin 140 to which the coil 142 and the fixed terminals 111a and 111b are attached is connected to the base 160 depicted in FIGS. 4C and 4D. FIGS. 4C and 4D are a side view and a cross-sectional view, respectively, of the base 160.

The base 160 includes an opening 161 for inserting the coil 142. The bobbin 140 is joined to the base 160, so that the coil 142 is surrounded by the base 160 and the bobbin 140 as depicted in FIG. 4E. Referring to FIGS. 4E and 4F, the fixed terminals 111a and 111b are positioned outside the bobbin 140 and the base 160 to cover the exterior of the bobbin 140 and the base 160. As illustrated in FIG. 4F, the movable spring 121 is installed from outside the base 160. Thereafter, a cover 170 is provided on the structure of FIG. 4E as illustrated in FIGS. 5A and 5B, and the cover 170 is bonded to the base 160 as depicted in FIGS. 5C and 5D. As a result, the electromagnetic relay is manufactured. FIGS. 5A and 5B are a perspective view and a partial cross-sectional view, respectively, of the electromagnetic relay before the cover 170 is bonded to the base 160. FIGS. 5C and 5D are a perspective view and a partial cross-sectional view, respectively, of the electromagnetic relay in which the cover 170 is bonded to the base 160.

The movable spring terminal 150 is fixed to the base 160 using the adhesive 180. The adhesive 180, which is liquid, is likely to wet and spread if supplied on a flat surface. Accordingly, if the movable spring terminal 150 were formed flat, the adhesive 180 might wet and spread up to an area between the movable spring terminal 150 and the movable spring 121 and further to the movable contacts 120a and 120b, thus causing a contact failure or malfunction.

Therefore, according to this embodiment, as illustrated in FIGS. 3A, 3B, 4E and 4F, the movable spring terminal 150 includes depressions 152 to collect the adhesive 180 to prevent the adhesive 180 from wetting and spreading. As a result, the reliability of the electromagnetic relay is increased.

According to this embodiment, the adhesive 180 is provided and cured between the base 160 and the movable spring terminal 150. As a result, as illustrated in FIGS. 5C and 5D, the movable spring terminal 150 and the fixed terminals 111a and 111b are bonded to the base 160, and the base 160 and the cover 170 are bonded together. Accordingly, the adhesive 180 remains in the depressions 152 of the movable spring terminal 150 to be prevented from wetting and spreading further. Therefore, the highly reliable electromagnetic relay is obtained.

According to this embodiment, the same as the movable spring terminal 150, the fixed terminals 111a and 111b may include depressions where the fixed terminals 111a and 111b are bonded to the base 160 by the adhesive 180. This also can prevent the adhesive 180 from wetting and spreading.

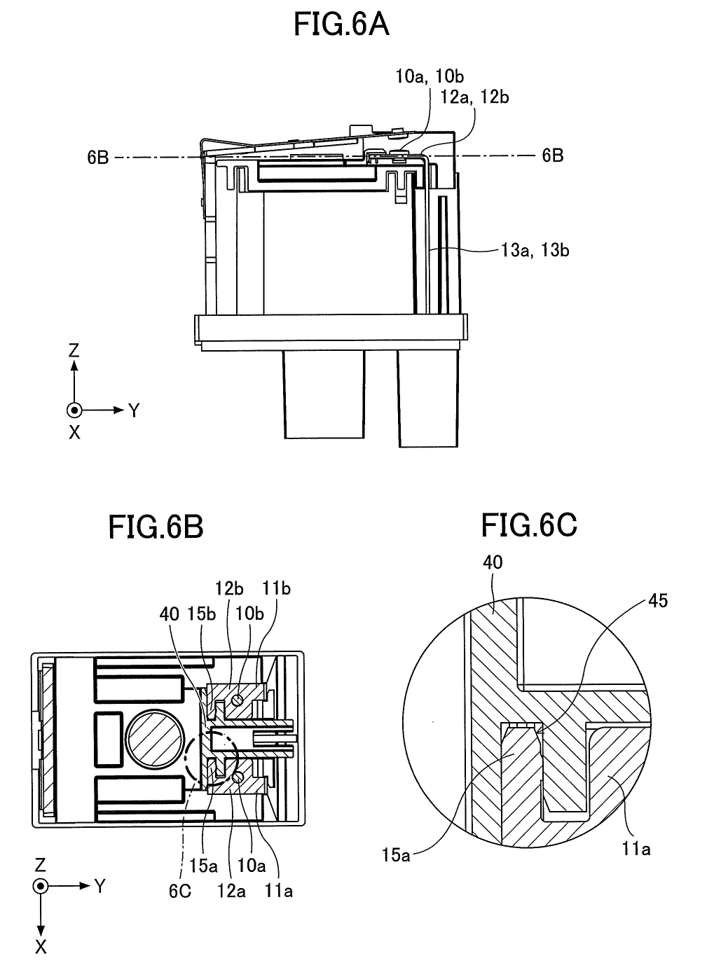

Next, the electromagnetic relay according to this embodiment is described in comparison with a comparative electromagnetic relay illustrated in FIGS. 6A through 6C. FIG. 6A is a cross-sectional view of part of the comparative electromagnetic relay where fixed contacts 10a and 10b are formed, taken along a plane parallel to the Y-Z plane. FIG. 6B is a cross-sectional view of the comparative electromagnetic relay, taken along a plane parallel to the X-Y plane, indicated by the line 6B-6B in FIG. 6A. FIG. 6C is an enlarged view of an area encircled by the one-dot chain line 6C in FIG. 6B. According to the comparative electromagnetic relay depicted in FIGS. 6A through 6C, contact parts 12a and 12b of fixed terminals 11a and 11b are provided with fixed contacts 10a and 10b, respectively, and with press-fitting protrusions 15a and 15b for attaching the fixed terminals 11a and 11b to a bobbin 40, respectively.

When attaching the fixed terminals 11a and 11b to the bobbin 40, the press-fitting protrusions 15a and 15b are press-fitted into corresponding openings 45 of the bobbin 40. When press-fitted into the openings 45, the press-fitting protrusions 15a and 15b may scrape off resin around the openings 45 to produce shavings, which may adhere to, for example, the fixed contacts 10a and 10b to cause an electrical connection failure. According to the comparative electromagnetic relay, the fixed contact 10a and the press-fitting protrusion 15a are formed on the same contact part 12a and are close to each other, and the fixed contact 10b and the press-fitting protrusion 15b are formed on the same contact part 12b and are close to each other. Therefore, the shavings that the press-fitting protrusions 15a and 15b produce by scraping off resin are likely to adhere to the fixed contacts 10a and 10b to cause an electrical connection failure.

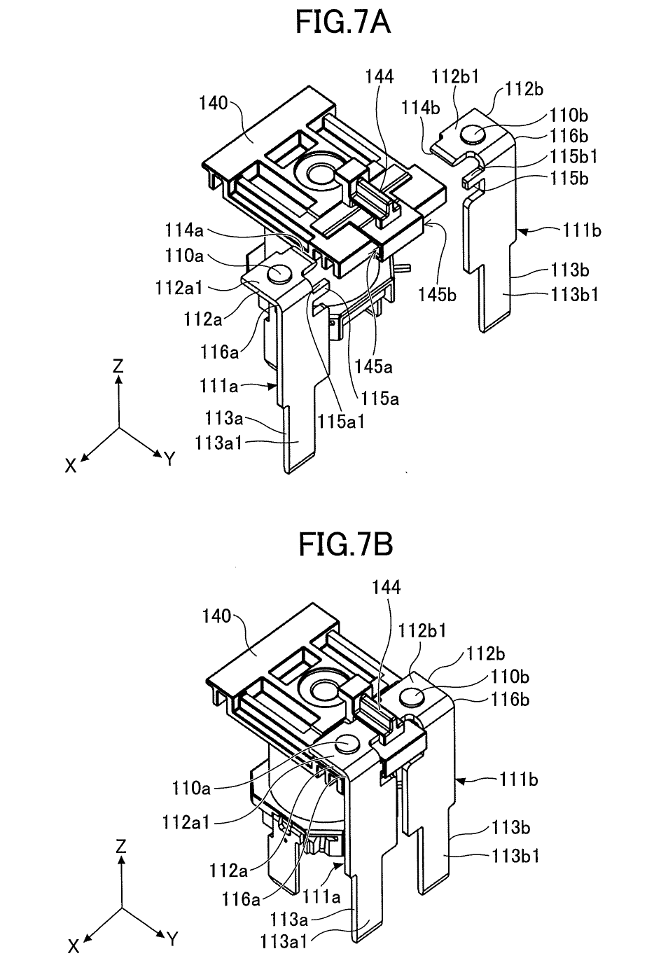

FIGS. 7A through 9B are diagrams illustrating the connection of the fixed terminals 111a and 111b to the bobbin 140 in the electromagnetic relay according to this embodiment.

FIG. 7A is an exploded perspective view of the fixed terminals 111a and 111b and the bobbin 140. FIG. 7B is a perspective view of the fixed terminals 111a and 111b and the bobbin 140 that are connected to each other.

According to this embodiment, as illustrated in FIGS. 7A and 7B, the fixed terminal 111a, which may be formed of a single metal plate by blanking and bending, includes a contact part 112a, a terminal part 113a, a press-fitting protrusion 115a, and a bent part 116a, which are formed together as one piece. The contact part 112a includes a surface 112a1 on which the fixed contact 110a is formed. The bent part 116a extends from the contact part 112a to be bent substantially at a right angle relative to the contact part 112a. The terminal part 113a extends from the bent part 116a to be elongated in a direction substantially perpendicular to the surface 112a1 of the contact part 112a. That is, the terminal part 113a is absent in a plane in which the contact part 112a (for example, the surface 112a1) is positioned. An end portion of the terminal part 113a protrudes from the base 160 to be exposed outside the cover 170 as depicted in, for example, FIGS. 5A and 5C.

Likewise, the fixed terminal 111b, which may be formed of a single metal plate by blanking and bending, includes a contact part 112b, a terminal part 113b, a press-fitting protrusion 115b, and a bent part 116b, which are formed together as one piece. The contact part 112b includes a surface 112b1 on which the fixed contact 110b is formed. The bent part 116b extends from the contact part 112b to be bent substantially at a right angle relative to the contact part 112b. The terminal part 113b extends from the bent part 116b to be elongated in a direction substantially perpendicular to the surface 112b1 of the contact part 112b. That is, the terminal part 113b is absent in a plane in which the contact part 112b (for example, the surface 112b1) is positioned. An end portion of the terminal part 113b protrudes from the base 160 to be exposed outside the cover 170 as depicted in, for example, FIGS. 5A and 5C.

The contact part 112a is provided with the fixed contact 110a and includes a contact portion 114a that contacts part of the bobbin 140 for the positioning of the fixed terminal 111a relative to the bobbin 140 when attaching the fixed terminal 111a to the bobbin 140. The press-fitting protrusion 115a extends (protrudes) from the terminal part 113a to be attached to the bobbin 140. Likewise, the contact part 112b is provided with the fixed contact 110b and includes a contact portion 114b that contacts part of the bobbin 140 for the positioning of the fixed terminal 111b relative to the bobbin 140 when attaching the fixed terminal 111b to the bobbin 140. The press-fitting protrusion 115b extends (protrudes) from the terminal part 113b to be attached to the bobbin 140.

According to this embodiment, the press-fitting protrusion 115a is formed not on the contact part 112a but on the terminal part 113a. Likewise, the press-fitting protrusion 115b is formed not on the contact part 112b but on the terminal part 113b.

A positioning part 144 for inserting the contact portions 114a and 114b and openings 145a and 145b for inserting the press-fitting protrusions 115a and 115b, respectively, are formed in the bobbin 140. According to this embodiment, the contact portions 114a and 114b contact the positioning part 144 to position the fixed terminals 111a and 111b, respectively, relative to the bobbin 140. Furthermore, the press-fitting protrusions 115a and 115b are press-fitted into the openings 145a and 145b, respectively.

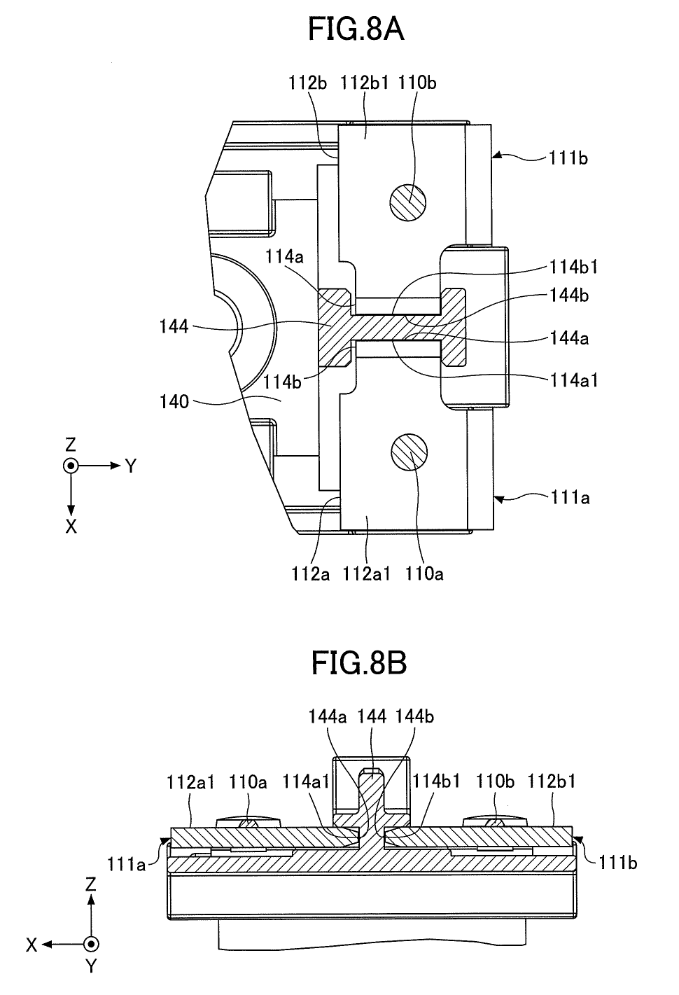

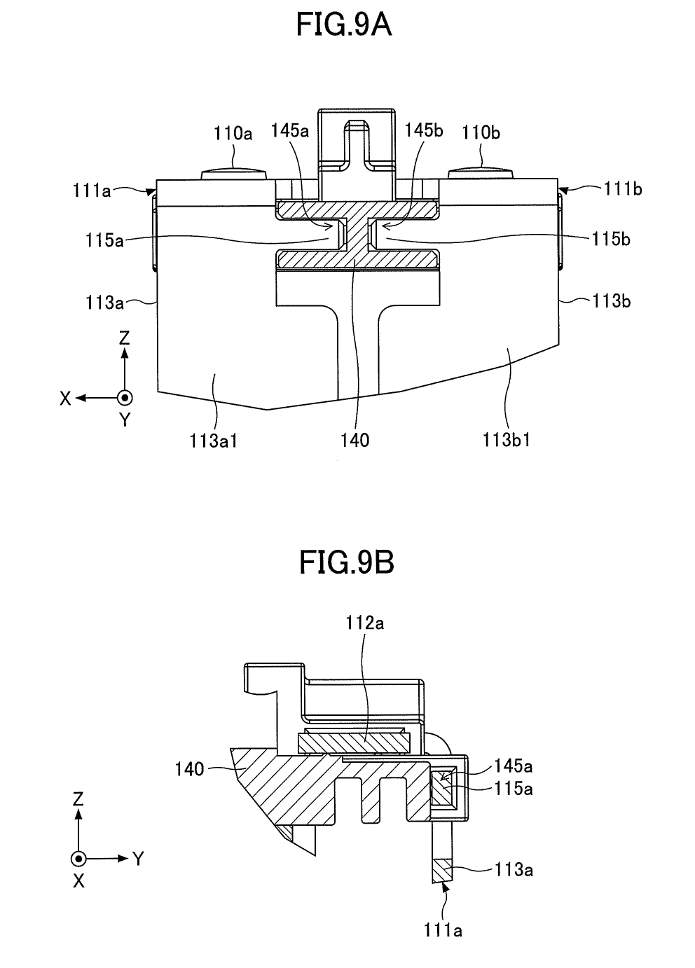

FIG. 8A is a cross-sectional view of part of the electromagnetic relay where the fixed contacts 110a and 110b are formed, taken along a plane parallel to the X-Y plane. FIG. 8B is a cross-sectional view of part of the electromagnetic relay where the fixed contacts 110a and 110b are formed, taken along a plane parallel to the X-Z plane. FIG. 9A is a cross-sectional view of part of the electromagnetic relay where the press-fitting protrusions 115a and 115b are formed, taken along a plane parallel to the X-Z plane. FIG. 9B is a cross-sectional view of part of the electromagnetic relay where the press-fitting protrusions 115a and 115b are formed, taken along a plane parallel to the Y-Z plane.

As illustrated in FIGS. 8A and 8B, an end face (surface) 114a1 of the contact portion 114a contacts a positioning contact surface 144a of the positioning part 144 to position the fixed terminal 111a relative to the bobbin 140. Likewise, an end face (surface) 114b1 of the contact portion 114b contacts a positioning contact surface 144b of the positioning part 144 to position the fixed terminal 111b relative to the bobbin 140. At the same time, as illustrated in FIGS. 9A and 9B, the press-fitting protrusion 115a is press-fitted into the opening 145a to attach the fixed terminal 111a to the bobbin 140, and the press-fitting protrusion 115b is press-fitted into the opening 145b to attach the fixed terminal 111b to the bobbin 140.

According to this embodiment, in the fixed terminal 111a, the fixed contact 110a is formed on the contact part 112a, and the press-fitting protrusion 115a is formed on the terminal part 113a to protrude in the same direction as the end face 114a1 of the contact portion 114a faces. Likewise, in the fixed terminal 111b, the fixed contact 110b is formed on the contact part 112b, and the press-fitting protrusion 115b is formed on the terminal part 113b to protrude in the same direction as the end face 114b1 of the contact portion 114b faces.

More specifically, the fixed contact 110a is formed on the surface 112a1 of the contact part 112a facing away from the base 160 (see FIGS. 4E and 4F) or facing in a direction opposite to the direction in which the terminal part 113a is elongated, and the press-fitting protrusion 115a is formed at (in a same plane as) a surface 113a1 of the terminal part 113a substantially perpendicular to the surface 112a1 of the contact part 112a. Likewise, the fixed contact 110b is formed on the surface 112b1 of the contact part 112b facing away from the base 160 (see FIGS. 4E and 4F) or facing in a direction opposite to the direction in which the terminal part 113b is elongated, and the press-fitting protrusion 115b is formed at (in a same plane as) a surface 113b1 of the terminal part 113b substantially perpendicular to the surface 112b1 of the contact part 112b.

Thus, the fixed contact 110a and the press-fitting protrusion 115a are formed on or at different surfaces of the fixed terminal 111a and are distant from each other, and the fixed contact 110b and the press-fitting protrusion 115b are formed on or at different surfaces of the fixed terminal 111b and are distant from each other.

From another perspective, the contact part 112a on which the fixed contact 110a is provided and the terminal part 113a including the press-fitting protrusions 115a are positioned in different planes, and the contact part 112b on which the fixed contact 110b is provided and the terminal part 113b including the press-fitting protrusions 115b are positioned in different planes. From yet another perspective, the surface 112a1 of the contact part 112a and a surface 115a1 of the press-fitting protrusion 115a facing in the same direction as the surface 112a1 are in different planes substantially parallel to each other, and the surface 112b1 of the contact part 112b and a surface 115b1 of the press-fitting protrusion 115b facing in the same direction as the surface 112b1 are in different planes substantially parallel to each other.

Accordingly, even if the press-fitting protrusions 115a and 115b scrape off part of the bobbin 140 to generate shavings when press-fitted into the openings 145a and 145b, respectively, the shavings are less likely to reach and adhere to the fixed contacts 110a and 110b. Therefore, the occurrence of an electrical connection failure is reduced.

Furthermore, when an electromagnetic relay is used for DC high voltage, an overcurrent may flow or an arc may be generated between a fixed contact and a movable contact to increase the temperature of the fixed contact. A mold resin softens to deform at approximately 200° C. Therefore, when the fixed contacts 10a and 10b and the press-fitting protrusions 15a and 15b are formed in the contact parts 12a and 12b as depicted in FIGS. 6A through 6C, heat generated in the fixed contacts 10a and 10b is likely to be transferred to the press-fitting protrusions 15a and 15b because of a short distance between the fixed contacts 10a and 10b and the press-fitting protrusions 15a and 15b. Therefore, the temperature of the press-fitting protrusions 15a and 15b increases. As a result, the bobbin 40 may melt and deform because of the heat of the press-fitting protrusions 15a and 15b, so that the press-fitting protrusions 15a and 15b may disengage from the bobbin 40.

According to this embodiment, the fixed contacts 110a and 110b are formed on the contact parts 112a and 112b, respectively, and the press-fitting protrusions 115a and 115b are formed on the terminal parts 113a and 113b, respectively. Therefore, the fixed contact 110a and the press-fitting protrusion 115a are formed on or at different surfaces of the fixed terminal 111a and are distant from each other, and the fixed contact 110b and the press-fitting protrusion 115b are formed on or at different surfaces of the fixed terminal 111b and are distant from each other. Accordingly, compared with the structure illustrated in FIGS. 6A through 6C, heat at the fixed contacts 110a and 110b is diffused, and less heat is transferred up to the press-fitting protrusions 115a and 115b. Therefore, the temperature of the press-fitting protrusions 115a and 115b is less likely to increase until melting the bobbin 140 to which the press-fitting protrusions 115a and 115b are press-fitted. Therefore, even when the temperature of the fixed contacts 110a and 110b increases, the fixed terminals 111a and 111b are less likely to disengage from the bobbin 140. Accordingly, the reliability of the electromagnetic relay is increased.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority or inferiority of the invention. Although one or more embodiments of the present invention have been described in detail, it should be understood that the various changes, substitutions, and alterations could be made hereto without departing from the spirit and scope of the invention.

What is claimed is:

1. An electromagnetic relay comprising:
a base;
a bobbin fixed to the base;
a coil attached to the bobbin;
a movable spring terminal fixed to the base;
a movable spring fixed to the movable spring terminal and including a movable contact; and
a fixed terminal fixed to the base, and including
a contact part on which a fixed contact is provided; and
a terminal part absent in a plane in which the contact part is positioned, the terminal part including a press-fitting protrusion press-fitted into an opening of the bobbin.

2. The electromagnetic relay as claimed in claim 1, wherein the bobbin includes a positioning part that contacts a surface of the contact part to position the fixed terminal relative to the bobbin.

3. The electromagnetic relay as claimed in claim 2, wherein
the terminal part is elongated in a direction substantially perpendicular to a surface of the contact part on which the fixed contact is provided, and
the press-fitting protrusion protrudes in a same direction as the surface of the contact part contacted by the positioning part faces.

4. The electromagnetic relay as claimed in claim 3, wherein the surface of the contact part on which the fixed contact is provided and a surface of the press-fitting protrusion facing in a same direction as the surface of the contact part on which the fixed contact is provided are positioned in different planes substantially parallel to each other.

5. The electromagnetic relay as claimed in claim 1, wherein at least one of the fixed terminal and the movable spring terminal includes a depression at which the at least one of the fixed terminal and the movable spring terminal is fixed to the base.

6. The electromagnetic relay as claimed in claim 1, wherein a surface of the contact part on which the fixed contact is provided and a surface of the press-fitting protrusion facing in a same direction as the surface of the contact part are positioned in different planes substantially parallel to each other.

7. The electromagnetic relay as claimed in claim 1, wherein
the fixed terminal further includes a bent part extending from the contact part and bent substantially at a right angle relative to the contact part, and
the terminal part extends from the bent part to be elongated in a direction substantially perpendicular to a surface of the contact part on which the fixed contact is provided.
